(19) United States
(12) Patent Application Publication
(10) Pub. No.: US 2004/0068881 A1
(43) Pub. Date: Apr. 15, 2004

(54) Viscous coupled micro interposer

(75) Inventors: Timothy Moriarity, Rochester, NY (US); Karl J. Lenz, Wiesbaden (DE)

Correspondence Address: Shlesinger, Fitzsimmons & Shlesinger, Suite 1323, 183 East Main Street, Rochester, NY, 14604, US

(73) Assignee: Optical Gaging Products, Inc.

(21) Appl. No.: 10/270,418

(22) Filed: Oct. 15, 2002

(51) Int. Cl. G01B 5/00

(52) U.S. Cl. 33/556

(57) ABSTRACT

An optical inspection equipment of the type having an actuator arm for supporting on one end thereof a touch probe beneath an optical system of the equipment, comprises a housing secured to one end of the arm and having therethrough a vertical bore registering with said optical system; a micro interposer in the form of an elongate generally rigid wire strand having on one end thereof a bead of only slightly larger diameter than the strand; and means viscously supporting the strand adjacent the opposite end thereof in the bore in the housing with one end thereof extending out of the bore beneath the housing, the means being operative normally to maintain the strand coaxially of the bore.

### BACKGROUND OF THE INVENTION

This invention relates to video-based optical inspection equipment, and more particularly to a novel touch probe or micro interposer for use with such equipment, and which is particularly suitable for measuring the features of prismatic and circular surfaces, such as for example the inside surface of a cylindrical bore wall, or the like.

During use of optical inspection equipment, and particularly the type designed for a high magnification and low f/number video system, it is ordinarily impossible to measure certain features, such as for example the inside surface of a cylindrical hole aligned with the optical axis, because there is no proper focus on such a surface. However, if an interposer, such as a tiny ball or disc secured to the end of a touch probe, is brought into contact with such a surface, where that ball is in the object plane of the optical system, the resulting image of the ball can be used to determine the contact point, and thereby to measure such a feature from a plurality of such contact points. A variety of such touch probes, and apparatus for measuring features of an object engaged by the probes, are disclosed, for example in U.S. Pat. No. 6,412,329, U.S. Pat. No. 4,972,597, U.S. Pat. No. 6,370,788, U.S. Pat. No. 5,755,038 and U.S. Pat. No. 5,953,687. Typically, such probes include an elongate, rigid stylus having at its lower end a ball or disc-shaped interposer for engagement with an object, and with the upper end of the stylus movably connected to related sensing apparatus which can be utilized to determine the amount of deflection sensed by the rigid stylus which its ball or disc-shaped lower end is moved upon engagement with the surface of the object that is being inspected. In addition to a probe employing a rigid stylus, U.S. Pat. No. 5,594,668, and European Patent application EP 0988505 B1 each teach the use of flexible probes which are specifically designed to be bent upon engagement of the associated probe tip with the surface that is being inspected.

A major problem encountered with prior such probes is the fact that they are mounted in such manner that they often are subject to damage during use, and consequently require not infrequent replacement of portions of the associated probe, particularly in the case of a probe having a rigid stylus. Likewise the interposer ball normally is not in the object plane of the optical system, so measurement of a feature depends solely upon mechanically and electrically sensing and calculating the movement of the ball upon its engagement with the surface that is being inspected.

It is an object of this invention, therefore, to provide an improved interposer device and associated video inspection system therefor, wherein the inspection apparatus provides light sources to illuminate the tip of a micro interposer or probe, and means to position the device so that the probe tip can be brought into contact with surfaces at desired locations on the inspected object.

A further object of this invention is to provide an improved micro interposer in the form of a long, spring steel strand which is held by a mechanism designed to minimize obstruction of the associated optical system.

Still another object of this invention is to provide a novel micro interposer manipulated by an actuator arm and a means for adjusting the length of the arm radially of a vertical axis, the angle of the arm about the vertical axis, and the height of the arm on the vertical axis relative to the inspected surface, thereby to locate the probe in focus in the center of the field of view.

A still further object of this invention is to provide a novel micro interposer in the form of an elongate, generally rigid wire strand having a diameter of only a fraction of a millimeter, a small, ball-shaped bead secured to its lower end, and having viscous means supporting the upper end of the strand on the free end of the actuator arm for limited swinging movement relative thereto.

Other objects of the invention will be apparent hereinafter from the specification and from the recite of the amended claims, particularly when read in conjunction with the accompanying drawings.

### SUMMARY OF THE INVENTION

The actuator or support arm for a touch probe or micro interposer made according to this invention is adjustably mounted at one end thereof beneath and connected to the optical system of conventional inspection equipment of the type in which the optical system is mounted for vertical movement. Secured to the opposite end of the support arm is a touch probe or micro interposer housing having therethrough an axial bore supported by the arm coaxially of the optical axis of the associated optical system. The interposer housing has in its upper end a rather shallow counterbore having secured coaxially therein a rigid disc having coaxially therethrough a central opening substantially the upper half of which is circular and the lower half of which is frusto conical in configuration. This disc has an extremely flat, smooth upper surface covered by a layer of viscous fluid. A second, smaller disc is seated on the viscous fluid coaxially of the larger, lower disc, and has therethrough a central opening in which is secured the upper end of an elongate substantially rigid micro interposer in the form of an elongate needle-like spring steel strand or pin wire of extremely small diameter. The interposer strand extends coaxially downwardly through the central opening in the lower disc and beneath the lower end of the interposer housing. Secured to the lower end of the micro interposer is a small, spherically shaped ball disposed to be engaged by the surface of the object that is being inspected. When the ball is engaged by a feature on the surface of a workpiece that is being inspected, it may be urged in a direction to cause the interposer strand to be tilted slightly out of coxial relationship with the bore in the interposer housing, and at the same time causing the upper, smaller disc to which it is attached, to be tilted slightly adjacent one diametrally side thereof above the upper surface of the lower, stationary disc, but in a manner that it still remains engaged with the layer of viscous fluid. Accordingly as soon as the inspected surface disengages the ball the viscous fluid causes the upper disc to return to coplanar engagement with the upper surface of the lower disc, and returns the interposer strand to its rest position coaxially of the bore in the interposer housing.

In order to be able to adjust the interposer into a position in which it is disposed coaxially of the optical axis of the associated optical system, the interposer supporting arm at the end thereof remote from the interposer is mounted for limited horizontal adjustment, limited vertical adjustment, and for limited angular adjustment about a vertical axis relative to the associated optical system.

### BRIEF DESCRIPTION OF THE DRAWINGS

FIG. 1 is a side elevational view of the viscous coupled micro interposer in the form of an elongate, generally rigid wire strand carried by an actuator arm for positioning the interposer coaxially of the optical axis of associated optical inspection equipment;

FIG. 2 is a perspective view of the microbe interposer and actuator arm therefor as shown in FIG. 1;

FIG. 3 is a slightly enlarged sectional view of the viscous coupled micro interposer taken along the line 3-3 in FIG. 1 looking in the direction of the arrows, and showing the interposer in its at rest position as it appears before coming into contact with the surface of a workpiece that is being inspected; and

FIG. 4 is a view similar to FIG. 3 but showing the interposer fragmentarily, and as it appears upon being slightly deflected by a surface of an object that is being inspected.

### DETAILED DESCRIPTION OF THE PREFERRED EMBODIMENTS

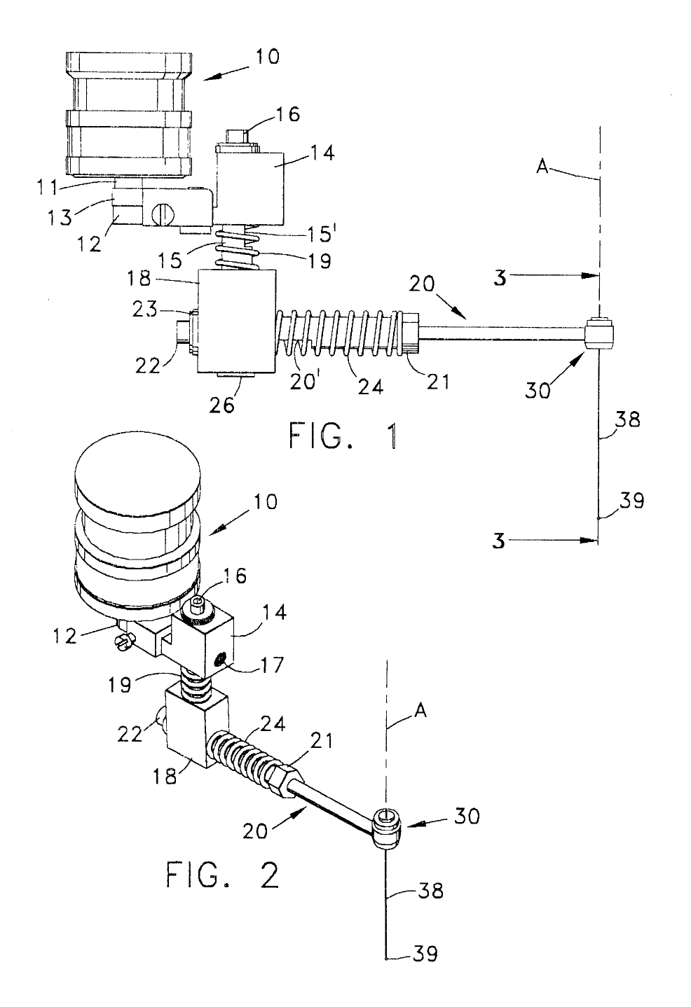

Referring now to the drawings by numerals of reference, and first to FIGS. 1 and 2, 10 denotes generally a detachable stylus module, which is sold by Renishaw plc., and which, in use, is magnetically coupled to a retaining module (not illustrated) carried by the optical system of inspection equipment sold by the assignee of this application under the registered trademark SMARTSCOPE ZIP. A cylindrical post 11 which projects coaxially from the underside of module 10 has secured thereon by a bolt 12 an elongate bracket 13 the opposite end of which has secured thereon in radially spaced relation to module 10 a housing 14. Housing 14 has therethrough a vertical bore which extends parallel to the axis of the module 10, and which has the upper end of a shaft 15 slidably guided for vertical adjustment in its bore by a bolt 16 having an externally threaded shaft which extends into the bore in housing 14 and is threaded into an internally threaded bore formed in the upper end of shaft 15. In its opposite, lower end shaft 15 is secured to the upper end of an actuator arm housing 18, and is surrounded between housings 14 and 18 by a compression spring 19 for a purpose noted hereinafter. Also, a screw 17 (FIG. 2) which is threaded into the side of housing 14 remote from module 10 has its inner end slidably engaged with a flat surface 15′ formed on the upper end of shaft 15 to prevent rotation thereof relative to housing 14.

Numeral 20 denotes generally an interposer actuating arm having intermediate its ends an enlarged-diameter, circumferential shoulder 21, and having one end thereof (the left end in FIG. 1) axially slidable in a horizontally disposed bore extending through housing 18 medially of its sides. The end of arm 20 that extends into the bore in housing 18 has an internally threaded axial bore into one end of which is rotatably adjusted the externally threaded end of an adjusting bolt 22 the head of which rotatably overlies a conventional washer 23 engaged with the end of housing 18 remote from the end into which arm 20 extends. The section of the arm 20 between its shoulder 21 and housing 18 is surrounded by a coiled compression spring 24 for a purpose to be noted hereinafter. Like shaft 15, arm 20 is prevented from rotating relative to housing 18 by a screw 26 threaded into the bottom of housing 18 and having its inner end slidably engaged with an axially extending flat surface 20′ formed on the end of arm 20 that is slidable in housing 18.

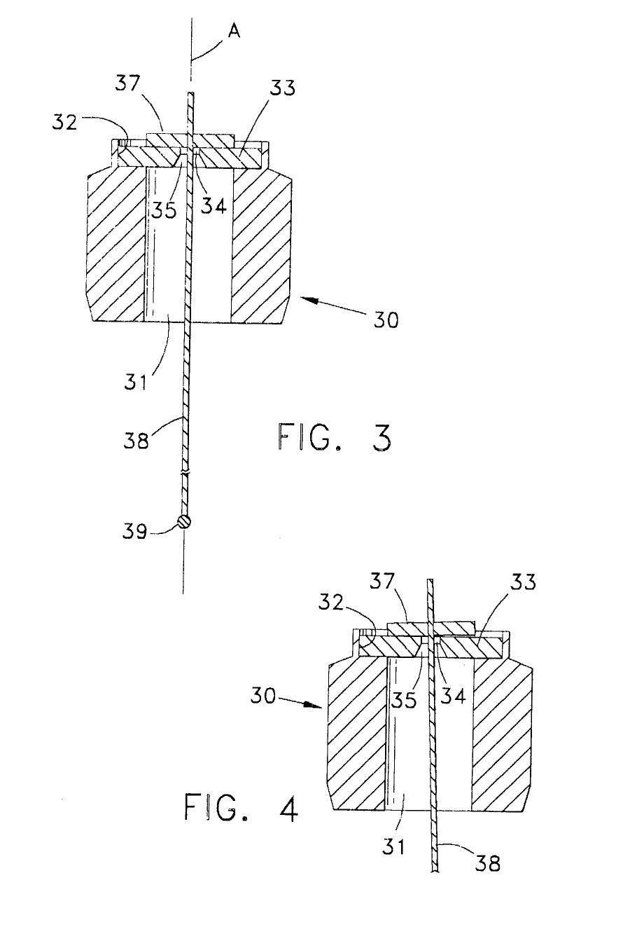

Secured to the end of arm 20 remote from the housing 18 is a generally cylindrically shaped interposer housing denoted generally by the numeral 30. As shown in FIG. 3, housing 30 has therethrough a vertically disposed axial bore 31 which, as noted hereinafter, is supported by arm 20 coaxially of the optical axis A of the associated inspection equipment. Secured coaxially in a shallow counterbore 32 formed in the upper end of bore 31 is a rigid disc 33 made of a synthetic saphire or ruby material similar to the composition of jewel bearings. The overall height or thickness of disc 33 is slightly less than the axial length of the counterbore 32, so that the upper surface of the disc is slightly spaced axially inwardly from the upper, terminal end of housing 30. Disc 33 has coaxially through the center thereof a central opening substantially the upper half of which is circular and is bound by an annular wall surface 34, while substantially the lower half of the opening is conical in configuration and is bound by a frusto conical surface 35, the upper end of which registers with the lower end of surface 34, and the lower end of which opens on the lower surface of disc 33.

The upper surface of disc 33, which is extremely smooth and flat, is covered by a thin layer of a viscous fluid, such as oil, and has seated centrally thereon another circular, rigid disc 37, which is made of the same material as disc 33. Secured adjacent its upper end in a central opening in disc 37, and extending coaxially downwardly through the central opening 34, 35 and the bore 31 and beyond the lower end of housing 30, is an elongate micro interposer 38 in the form of an elongate needle-like spring steel strand or pin wire of extremely small diameter, for example in the range of 0.0025 to 0.004 of an inch. Interposer 38 has secured centrally to the lower end thereof a tiny ball or disc, which in the illustrated embodiment constitutes a tiny, spherically shaped ball 39 of only slightly larger diameter than the strand 38. The bottom surface of disc 37, which seats on the viscous fluid covering the upper surface of disc 33 likewise is extremely smooth and flat.

Normally the viscous fluid interposed between the discs 33 and 37 maintains the interposer strand 38 coaxially of the bore 31 in housing 30, as shown in FIG. 3. However, during use, as noted hereinafter, when the ball 39 becomes engaged with a surface that is being inspected, the surface may cause the interposer 38 to be swung slightly, as a unit, along with its supporting disc 37, into any one of a number of different positions in which it is inclined to the axis of the bore 31, as shown for example in FIG. 4, wherein the interposer 38 has been swung slightly counterclockwise, thereby causing its supporting disc 37 to be tilted slightly relative to the upper surface of the disc 33, and against the resistance of the viscous fluid upon which it is seated. Therefore, as soon as the ball 39 no longer is engaged by a surface of the object that is being inspected, the viscous fluid between the discs 33 and 37 will cause the disc 37 to return to its stable, inoperative position, as shown in FIG. 3, wherein the interposer 38 is once again returned to its position coaxially of the axial centerline of housing 30.

In use, the retaining module to which the stylus module 10 is secured, is fixed with respect to the optical system of the associated inspection equipment, such as for example the type sold under the above-noted trademark SMARTSCOPE ZIP. This equipment functions to support the module 10 in a position in which arm 20 supports the interposer housing 30 beneath the optical system of the inspection equipment where it is adjusted to place the micro strand 38 coaxially of the optical axis A of the associated optical system, and with its ball 39 in the object plane of the optical system. The foregoing adjustment of housing 30 can be effected, whenever necessary, by momentarily loosening screw 12 to enable rotational adjustment of housing 14 relative to the post 11 and hence with respect to module 10 and the optical system to which it is secured; bolt 16 may be adjusted to raise or lower the interposer supporting arm 20; and bolt 22 may be adjusted to shift housing 30 and hence interposer 38 horizontally relative to associated optical system.

The optical system referred to above, is mounted in a conventional manner in the associated equipment for vertical adjustment to raise and lower the interposer 38 and its ball 39 relative to a workpiece (not illustrated) that is being inspected. Typically such workpiece is mounted on a support for adjustment in a conventional manner horizontally in directions X and Y which extend at right angles to each other and at right angles to the optical axis A. The inspected workpiece can be illuminated by a light source located either above the housing 30 or beneath the adjustable work support. In either case, the interposer ball 39 remains in focus in the object plane of the associated optical system. When the ball 39 of the rigid micro interposer 38 is moved by a surface feature of an object that is being inspected, the movement is observed and the displacement recorded to effect measurement of the feature.

From the foregoing, it will be apparent that the present invention provides a novel probe in the form of an elongate micro interposer made from an essentially, rigid, needle-like spring steel strand, which is coupled to its support or actuator arm by a viscous fluid, which normally retains the strand in a rest position in which it is disposed coaxially of the optical axis of the associated optical system, and which, when the ball shaped operating end of the strand is engaged by the surface of an object that is being inspected, the strand is free to be tilted against the attraction of the viscous fluid, and to be returned to its rest position by the viscous fluid after the ball shaped end thereof is disengaged from the surface of the workpiece.

While this invention has been illustrated and described in connection with only certain embodiments thereof, it will be apparent to one skilled in the art that it is capable of still further modification, and that this application is intended to cover any such modifications as may fall within the scope of one skilled in the art, or the appended claims.

The claims:

1. An optical inspection equipment of the type having an actuator arm for supporting on one end thereof a touch probe beneath an optical system of the equipment, comprising;
a housing secured to said one end of said arm and having therethrough a vertical bore registering with said optical system;
a micro interposer in the form of an elongate generally rigid wire strand having on one end thereof a bead of only slightly larger diameter than said strand; and
means viscously supporting said strand adjacent the opposite end thereof in said bore in said housing with said one end thereof extending out of said bore beneath said housing, said means being operative normally to maintain said strand coaxially of said bore.

2. An optical inspection equipment as in claim 1, wherein said arm is adjustable horizontally and vertically.

3. An optical inspection equipment as in claim 1, wherein said housing is generally cylindrically shaped.

4. An optical inspection equipment of the type having an actuator arm for supporting on one end thereof a touch probe beneath an optical system of the equipment, comprising;
a housing secured to said one end of said arm and having therethrough a vertical bore registering with said optical system;
a micro interposer in the form of an elongate generally rigid wire strand having one end thereof a bead of only slightly larger diameter than said strand;
a first disc supported by said housing, said disc having a central opening;
a second disc disposed on top of said first disc;
a viscous liquid interposed said first and second discs; and
said strand being secured to said second disc and extending through said central opening, said first and second discs being operative normally to maintain said strand coaxially of said bore.

5. An optical inspection equipment as in claim 4, wherein said first and second discs are made of synthetic sapphire.

6. An optical inspection equipment as in claim 4, wherein said first and second discs are made of ruby material.

7. An optical inspection equipment as in claim 4, wherein said central bore is cylindrical and frusto-conical.

8. An optical inspection equipment as in claim 4, wherein said viscous liquid is oil.

9. An optical inspection equipment as in claim 4, wherein said arm is adjustable horizontally and vertically.

10. An optical inspection equipment as in claim 4, wherein said housing is generally cylindrically shaped.
